(19) United States
(12) Patent Application Publication
(10) Pub. No.: US 2022/0287806 A1
(43) Pub. Date: Sep. 15, 2022

(54) DISPOSABLE DENTAL ARTICULATOR

(71) Applicants: YUNSOON KIM, Duluth, GA (US); BRIAN SUNG BUM KIM, Duluth, GA (US)

(72) Inventors: YUNSOON KIM, Duluth, GA (US); BRIAN SUNG BUM KIM, Duluth, GA (US)

(21) Appl. No.: 17/201,015

(22) Filed: Mar. 15, 2021

(51) Int. Cl. A61C 11/08; A61C 13/34; A61C 11/02

(52) U.S. Cl. CPC A61C 11/08; A61C 13/34; A61C 11/022

(57) ABSTRACT

A disposable dental articulator is proposed. The disposable dental articulator includes a body, a socket coupled to the body and a fixing portion one side of which is slidably coupled to the first socket and the other side of which is configured to be coupled to one of a maxillary dental model and a mandibular dental model.

### BACKGROUND

### 1. Field

The present inventive concept relates to a disposable dental articulator. More particularly, the present inventive concept relates to a disposable dental articulator, wherein maxillary and mandibular dental models of the articulator are easily and accurately aligned in accordance with a dental shape of a patient, thereby accurately manufacturing a denture that is precisely processed and provides comfortable fit on a patient's gum.

### 2. Description of the Related Art

In general, articulators are used in dental clinics and dental laboratories. As described in Korean Patent No. 10-0417880 filed and registered by the applicant of the present inventive concept, in order to replace a missing tooth with an artificial tooth or make a dental prosthesis, a negative impression of a patient's teeth is made at a dental clinic and sent to a dental laboratory. In the dental laboratory, dental cement is injected into the impression to create a dental model. Depending on the number of teeth to be treated or involved in the prosthesis, dental models may be divided into a partial dental model for only a tooth to be treated, a unilateral dental model, and a bilateral dental model. According to relationship between teeth, a dental model for working teeth to be treated, or a dental model for antagonist teeth articulating with the working teeth may be manufactured.

When the dental models for the working teeth and antagonist teeth are manufactured, the relationship between teeth has to be determined in advance in order to manufacture a dental prosthesis and artificial teeth that mimic the dental occlusion and masticatory structure of the patient, and the structure of the maxilla and mandible of the patient has to be reproduced so that the optimal dental prosthesis and artificial teeth can be manufactured. A dental model articulator is a device designed to reproduce the structure of the maxilla and mandible conforming to the dental structure of the patient.

An example of the dental model articulator is disclosed in Korean Patent No. 10-0417880, entitled “Articulator for dental model”. The articulator A disclosed herein includes: a pair of base adapters 10 and 10′ each of which includes a body frame 15 configured such that a dental model is coupled to an upper surface thereof and a spherical control ball 16 protrudes from an outer end thereof, a plurality of locking pin fitting holes 14 formed at a regular interval in the center of the upper surface of the body frame 15, and character and reference teeth display parts 19′ and 19 provided at one side of the upper surfaces of the body frame 15 so as to easily determine a coupling position of the respective dental models when the dental models are separated and coupled; and a pair of connectors 20 and 21 made of a quadrangular channel-shaped plastic elastic material, and configured such that respective first ends thereof are coupled to the respective spherical control balls 16 of the base adapters 10 and 10′ and respective second ends thereof are hinged so as to be separated from each other by a pair of locking pieces 22 and one fitting piece 24. Here, pluralities of pyramids 12 and 13 are respectively provided at opposite sides of the locking pin fitting holes 14 formed in the body frame 15, the pyramids continuously protruding at a predetermined height to be inserted into the dental models coupled to the base adapters 10 and 10; each of the locking pin fitting holes 14 has a tapered shape of which the inner diameter gradually decreases from top to bottom; hemispherical housings 26 and 26′ are respectively provided at the connectors 20 and 21 in the width direction of the connectors 20 and 21 coupled to the spherical control balls 16, each of the housings having a cut upper end so that the spherical control balls 16 are fitted to the housings 26 and 26′ to be movable therein up, down, left, right, and laterally; and a plurality of glue injection slits 27 for fixing the fitted spherical control balls 16 are formed at one side of each of the housings 26 and 26′.

Another example of the dental model articulator is disclosed in Korean Utility Model Registration No. 20-0313638, entitled “Dental-technical bite instrument”. The instrument disclosed herein includes: an arm 18 having an end rotatably installed at a column 14 standing from an end of a base 12; and upper and lower locking means 40 and 30 provided respectively at the arm 18 and the base 12, and including grippers 33, 36, 43, and 46 operated by associated locking screws 38 and 48 to fix respectively upper and lower mouth models T1 and T2. Here, a metal storage chamber 41a open upward is formed on an upper surface of a gripper support plate 41 of the upper locking means 40; the metal storage chamber 41a is provided with a low-melting-point alloy 42 melted to a predetermined height and solidified; and the gripper support plate 41 has a first end fused to the low-melting-point alloy 42 to be fixed to the metal storage chamber 41a, and a second end connected to the arm 18 via a connecting bar 20 fixed by a fastening means to a distal end of the arm 18.

However, the articulators according to the related art have disadvantages in that it may be difficult to accurately manufacture a denture and to precisely process the denture and the manufactured denture may not fit comfortably on the patient's gum because maxillary and mandibular dental models are often misaligned when aligned in accordance with a dental shape and manipulation thereof is difficult.

The foregoing is intended merely to aid in the understanding of the background of the present inventive concept and is not intended to mean that the present inventive concept falls within the purview of the related art that is already known to those skilled in the art.

### SUMMARY

Accordingly, the present inventive concept has been made keeping in mind the above problems occurring in the related art and an objective of the present inventive concept is to provide a disposable dental articulator, wherein maxillary and mandibular dental models of the articulator are easily and accurately aligned in accordance with a dental shape of a patient, thereby accurately manufacturing a denture that is precisely processed and provides comfortable fit on a patient's gum.

In order to achieve the above objective, according to one aspect of the present inventive concept, there is provided a disposable dental articulator, including: a body; and a first socket coupled to the body and a first fixing portion one side of which is slidably coupled to the first socket and the other side of which is configured to be coupled to one of a maxillary dental model and a mandibular dental model.

The first body may include a first horizontal portion extending along a first direction, a first left leg and a first right leg connected to distal ends of the first horizontal portions and extending along a second direction substantially perpendicular to the first direction, and a first ball connected to a center of the first horizontal portion of the first body and extending along the second direction opposite to a direction the first left leg and the first right leg extend.

The first body may further include a left slit formed at an end of the left leg, a left hinge horizontally crossing the left slit along the first direction, and a right slit formed at an end of the right leg.

The first ball may include a groove disposed along a circumference of the first ball along a third direction perpendicular to a plane formed by the first direction and the second direction.

The first ball may include a groove disposed along a circumference of the first ball along a third direction perpendicular to a plane formed by the first direction and the second direction.

The first socket may further include a socket groove formed along a circumference of the concave portion of the first socket along the third direction in a region opposing the groove disposed along the circumference of the first ball thereby forming a glue passage which allows glue to be injected thereinto to firmly adhere the first ball to the concave portion of the first socket.

The disposable dental articulator may further include a second body, a second socket coupled to the second body, and a second fixing portion one side of which is slidably coupled to the second socket and the other side of which is configured to be coupled to the other of a maxillary dental model and a mandibular dental model.

The second body may include a second horizontal portion extending along the first direction, a second left leg and a second right leg connected to distal ends of the second horizontal portions and extending along the second direction substantially perpendicular to the first direction, and a second ball connected to a center of the second horizontal portion of the second body and extending along the second direction opposite to a direction the second left leg and the second right leg extend.

The second body may further include a left slit formed at an end of the left leg, a right slit formed at an end of the right leg, and a right hinge horizontally crossing the right slit along the first direction.

The second socket may include a concave portion to which the second ball is coupled.

The second socket may further include a socket groove formed along a circumference of the concave portion of the second socket along the third direction in a region opposing the groove disposed along the circumference of the second ball thereby forming a glue passage which allows glue to be injected thereinto to firmly adhere the second ball to the concave portion of the second socket.

The left hinge of the first body may be movably coupled to the left slit of the second body and the right hinge of the second body may be movably coupled to the right slit of the first body.

Therefore, the present inventive concept provides a remarkable effect in that the maxillary and mandibular dental models of the articulator can be easily and accurately aligned in accordance with a dental shape of the patient, thereby accurately manufacturing a denture that can be precisely processed and can provide comfortable fit on the patient's gum.

### BRIEF DESCRIPTION OF THE DRAWINGS

The above and other objectives, features, and other advantages of the present inventive concept will be more clearly understood from the following detailed description when taken in conjunction with the accompanying drawings, in which:

FIG. 1 is a perspective view illustrating a disposable dental articulator according to the present inventive concept;

FIG. 2 is a perspective view illustrating an upper body of a disposable dental articulator according to the present inventive concept;

FIG. 3 is a perspective view illustrating a lower body of the disposable dental articulator according to the present inventive concept;

FIG. 4 is a perspective view illustrating a socket of the disposable dental articulator according to the present inventive concept;

FIG. 5 is a perspective view illustrating another embodiment of a socket of the disposable dental articulator according to the present inventive concept;

FIG. 6 is a perspective view illustrating still another embodiment of a socket of the disposable dental articulator according to the present inventive concept;

FIG. 7 is a view illustrating a state in which a slide portion of the socket illustrated in FIG. 6 is combined with a fixing portion; and

FIG. 8 is a detailed view illustrating the slide groove of the fixing portion according to the present inventive concept.

### DETAILED DESCRIPTION OF THE INVENTIVE CONCEPT

Hereinbelow, an exemplary embodiment of the present inventive concept will be described in detail with reference to the accompanying drawings. Throughout the drawings, the same reference numerals will refer to the same or like parts.

The present inventive concept relates to a disposable dental articulator.

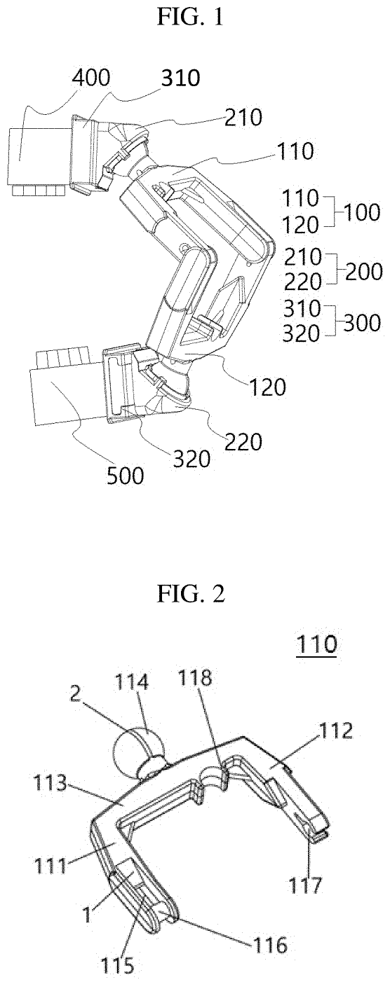

Referring to FIG. 1, the disposable dental articulator including a body 100, a socket 200 and a fixing portion 300. The body 200 includes an upper body 110 and a lower body 120. The socket 200 includes an upper socket 210 and a lower socket 220. The fixing portion 300 includes an upper fixing portion 310 and a lower fixing portion 320. The upper body 110 is coupled to the upper socket 210. The upper socket 210 is coupled to the upper fixing portion 310. The upper fixing portion 310 is configured to be coupled to a maxillary dental model 400. The lower body 120 is coupled to the lower socket 220. The lower socket 220 is coupled to the lower fixing portion 320. The lower fixing portion 320 is configured to be coupled to a mandibular dental model 500. The upper fixing portion 310 and the lower fixing portion 320 are couple to the maxillary dental model 400 and the mandibular dental model 500 using an adhesive, respectively.

Referring to FIG. 2, the upper body 110 may include a horizontal portion 113 that extends along a first direction, and a left leg 111 and a right leg 112 integrally and respectively formed at a left end and a right end of the horizontal portions 113, respectively. The left leg 111 and a right leg 112 may be formed to extend along a second direction substantially perpendicular to the first direction. An upper ball 114 may be formed to extend along the second direction opposite to the direction the left leg 111 and a right leg 112 extends from a center of the horizontal portion 113 of the upper body 110. A left slit 115 may be formed at an end of the left leg 111. A left hinge 116 may be integrally formed to cross the left slit 115 horizontally. A right slit 117 may be formed at an end of the right leg 112. The left slit 115 is formed to pass through the left leg 111 along a third direction which is perpendicular to a plane formed by the first direction and the second direction. The right slit 117 is formed to pass through the right leg 112 along the first direction.

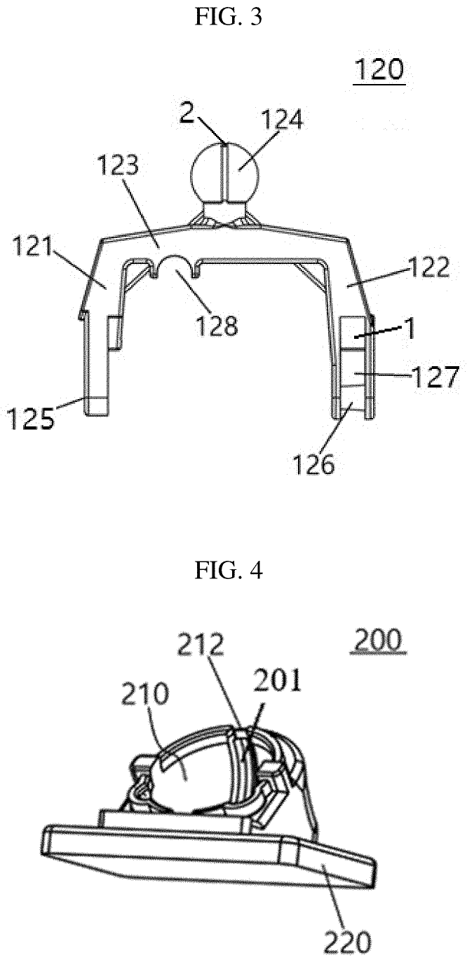

Referring to FIG. 3, the lower body 120 may include a horizontal portion 123 that extends along the first direction, and a left leg 121 and a right leg 122 integrally and respectively formed at a left end and a right end of the horizontal portions 123, respectively. The left leg 121 and a right leg 122 may be formed to extend along the second direction. A lower ball 124 may be formed to extend along the second direction opposite to the direction the left leg 121 and a right leg 122 extends from a center of the horizontal portion 123 of the lower body 120. A left slit 125 may be formed at an end of the left leg 121. A right slit 127 may be formed at an end of the right leg 122. The left slit 125 is formed to pass through the left leg 121 along the first direction. The right slit 127 is formed to pass through the right leg 122 along the third direction.

The left leg 111 of the lower body 110 and the left leg 121 of the lower body 120 is coupled to each other, and the right leg 112 of the upper body 110 and the right leg 122 of the lower body 120 is coupled to each other.

Each of the left leg 111 of the upper body 110 and the right leg 122 of the lower body 120 may have an inclined surface 1 which is slanted from front to rear to serve as a stopper to stop rotation when the upper body 110 and the lower body 120 is movably combined.

Further, the left hinge 116 of the upper body 110 and the right hinge 126 of the lower body 120 may have a trapezoidal cross-section in which each of a diameter of the left hinge 116 of the upper body 110 and the right hinge 126 of the lower body 120 gradually increases toward outside.

Referring back to FIG. 1, when combined, the left hinge 116 of the upper body 110 is movably coupled to the left slit 125 of the lower body 120, and the right hinge 126 of the lower body 120 is movably coupled to the right slit 117 of the upper body.

Referring to FIGS. 2 and 3, semi-circular ring-shaped gripping portions 118 and 128 may be respectively formed on lower surfaces of the horizontal portions 113 and 123 so that support rods for supporting the disposable dental articulator in an opened state are inserted into the gripping portions 118 and 128.

Further, the upper and lower bodies 110 and 120 may be disposed on the same plane when opened.

Further, a ball groove 2 may be formed along the circumference of each of the upper and lower balls 114 and 124 in the up-down direction.

Referring to FIG. 4, a socket groove 201 may be formed along the circumference of a concave portion 210 of the socket 200 in the up-down direction so that the ball groove 2 and the socket groove 201 may form a glue passage that allows glue to be injected thereinto to firmly adhere each of the upper ball 114 and the lower ball 124 to the concave portion 210 of the upper socket 210 and the lower socket 220 by the glue.

Further, each of the upper socket 210 and the lower socket 220 may include the concave portion 210 to which each of the upper ball 114 and the lower ball 124 is coupled. The fixing portion 220 may be coupled to a lower portion of the socket 200 so that each of the maxillary dental model 400 and the mandibular dental model 500 is coupled to the fixing portion 220.

The fixing portion 220 may have a rectangular plate shape.

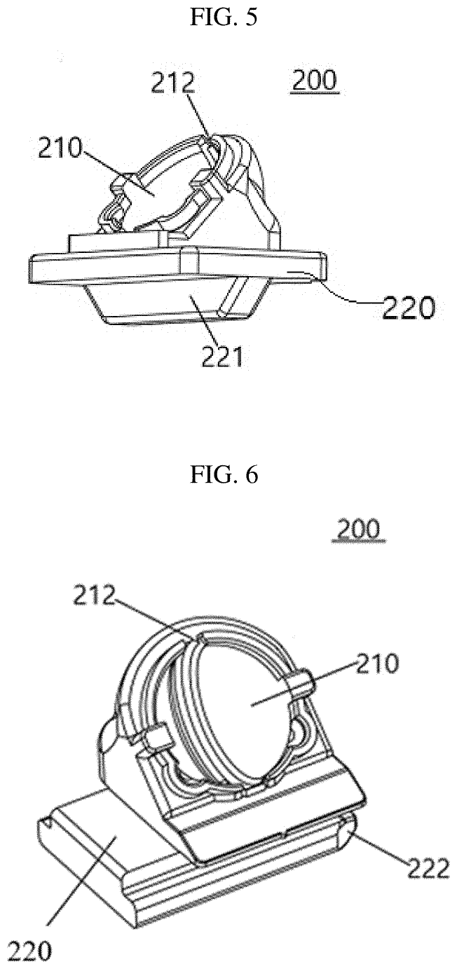

Referring to FIG. 5, a protrusion 221 may be formed at the center of a lower portion of the fixing portion 220. The protrusion 221 may extend along the first direction.

Referring to FIG. 6, slide portions 222 may be formed to protrude from the fixing portion 220 to the second direction perpendicular to the direction the protrusion 221 extends. The slide portions 222 may have a front slide portion which extends toward front direction and a rear slide portion which extends toward rear direction.

Referring to FIG. 8, each of the upper fixing portion 310 and the lower fixing portion 320 may include a slide groove 330 through which the slide portion 222 of the fixing portion 220 is slidably coupled.

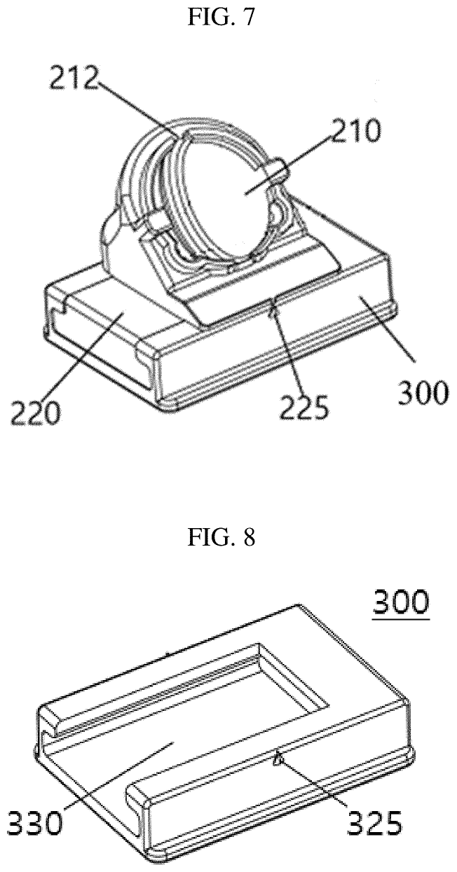

Referring to FIGS. 7 and 8, the socket 200 may include a first alignment mark 225 and the fixing portion 300 may include a second alignment mark 325. The first alignment mark 225 and the second alignment mark 325 may be an arrow which is printed on the outer periphery of the socket 200 and the fixing portion 300 to check whether the socket 200 and the fixing portion 300 align correctly with each other.

Further, the concave portion 210 may be configured such that a ridge and a valley are alternately repeatedly formed along the outer periphery of a concave recess 212.

Therefore, the present inventive concept provides a remarkable effect in that the maxillary and mandibular dental models of the articulator can be easily and accurately aligned in accordance with a dental shape of a patient, thereby accurately manufacturing a denture that can be precisely processed and can provide comfortable fit on a patient's gum.

Although a preferred embodiment of the present inventive concept has been described for illustrative purposes, those skilled in the art will appreciate that various modifications, additions and substitutions are possible, without departing from the scope and spirit of the inventive concept as disclosed in the accompanying claims.

What is claimed is:

1. A disposable dental articulator, comprising:
a first body;
a first socket coupled to the first body; and
a first fixing portion one side of which is slidably coupled to the first socket and the other side of which is configured to be coupled to one of a maxillary dental model and a mandibular dental model.

2. The disposable dental articulator of claim 1, wherein the first body comprises:
a first horizontal portion extending along a first direction;
a first left leg and a first right leg connected to distal ends of the first horizontal portions and extending along a second direction substantially perpendicular to the first direction; and
a first ball connected to a center of the first horizontal portion of the first body and extending along the second direction opposite to a direction the first left leg and the first right leg extend.

3. The disposable dental articulator of claim 2, wherein the first body further comprises:
a left slit formed at an end of the left leg;
a left hinge horizontally crossing the left slit along the first direction; and
a right slit formed at an end of the right leg.

4. The disposable dental articulator of claim 3, wherein the first ball comprises a groove disposed along a circumference of the first ball along a third direction perpendicular to a plane formed by the first direction and the second direction.

5. The disposable dental articulator of claim 4, wherein the first socket includes a concave portion to which the first ball is coupled.

6. The disposable dental articulator of claim 5, wherein the first socket further comprises a socket groove formed along a circumference of the concave portion of the first socket along the third direction in a region opposing the groove disposed along the circumference of the first ball thereby forming a glue passage which allows glue to be injected thereinto to firmly adhere the first ball to the concave portion of the first socket.

7. A disposable dental articulator of claim 2, further comprising:
a second body;
a second socket coupled to the second body; and
a second fixing portion one side of which is slidably coupled to the second socket and the other side of which is configured to be coupled to the other of a maxillary dental model and a mandibular dental model.

8. The disposable dental articulator of claim 7, wherein the second body comprises:
a second horizontal portion extending along the first direction;
a second left leg and a second right leg connected to distal ends of the second horizontal portions and extending along the second direction substantially perpendicular to the first direction; and
a second ball connected to a center of the second horizontal portion of the second body and extending along the second direction opposite to a direction the second left leg and the second right leg extend.

9. The disposable dental articulator of claim 8, wherein the second body further comprises:
a left slit formed at an end of the left leg;
a right slit formed at an end of the right leg; and
a right hinge horizontally crossing the right slit along the first direction.

10. The disposable dental articulator of claim 9, wherein the second socket includes a concave portion to which the second ball is coupled.

11. The disposable dental articulator of claim 10, wherein the second socket further comprises a socket groove formed along a circumference of the concave portion of the second socket along the third direction in a region opposing the groove disposed along the circumference of the second ball thereby forming a glue passage which allows glue to be injected thereinto to firmly adhere the second ball to the concave portion of the second socket.

12. The disposable dental articulator of claim 11, wherein the left hinge of the first body is movably coupled to the left slit of the second body and the right hinge of the second body is movably coupled to the right slit of the first body.
